(19) United States
(12) Patent Application Publication
(10) Pub. No.: US 2022/0346157 A1
(43) Pub. Date: Oct. 27, 2022

(54) Configuration for Random Access Procedure

(71) Applicant: Telefonaktiebolaget LM Ericsson (PUBL), Stockholm (SE)

(72) Inventors: Min Wang, Luleå (SE); Jan CHRISTOFFERSSON, Luleå (SE)

(21) Appl. No.: 17/765,255

(22) PCT Filed: Oct. 1, 2020
(86) PCT No.: PCT/EP2020/077521

§ 371 Date: Mar. 30, 2022

Related U.S. Application Data
(60) Provisional application No. 62/909,471, filed on Oct. 2, 2019.

(51) Int. Cl. H04W 74/08; H04W 72/12

(52) U.S. Cl. CPC H04W 74/0841; H04W 74/0875; H04W 72/1268; H04W 72/1247

(57) ABSTRACT

According to some embodiments, a method performed by a wireless device for two-step random access comprises determining a physical uplink shared channel (PUSCH) configuration for transmitting a first message of a two-step random access procedure. The PUSCH configuration is determined based on a characteristic or function of the wireless device. The method further comprises transmitting the first message of the two-step random access procedure to a network node using the determined PUSCH configuration.

### TECHNICAL FIELD

Embodiments of the present disclosure are directed to wireless communications and, more particularly, to multiple physical uplink shared channel (PUSCH) configurations for two-step random access (RA).

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Next generation (NG) wireless networks support a wide range of use cases with varying requirements ranging from fully mobile devices to stationary Internet-of-Things (IoT) or fixed wireless broadband devices. The traffic pattern associated with many use cases may include short or long bursts of data traffic with varying length waiting periods between bursts (referred to as an inactive state). Third Generation Partnership Project (3GPP) fifth generation (5G) new radio (NR) specifications include both license assisted access (LAA) and standalone operation in unlicensed spectrum (NR-U). 3GPP specifications also include physical random access channel (PRACH) transmission and/or scheduling request (SR) transmission in unlicensed spectrum.

Network operation in unlicensed spectrum includes a number of restrictions. One is that a device (e.g., a radio network node or a mobile terminal) has to monitor the shared medium, i.e. the channel, and determine that it is free (not being used by any other device) before starting to transmit on the channel. This procedure is referred to as listen-before-talk (LBT) or clear channel assessment (CCA)

Compared to long term evolution (LTE) LAA, NR-U also needs to support dual connectivity (DC) and standalone scenarios, where the media access control (MAC) procedures, including random access channel (RACH) and scheduling procedure on unlicensed spectrum, are subject to LBT and thus potential LBT failures. In LTE LAA, there are no such issues because the RACH and scheduling related signaling can be transmitted on the PCell in licensed spectrum instead of unlicensed spectrum.

For discovery reference signal (DRS) transmission such as primary synchronization signal (PSS)/secondary synchronization signal (SSS), physical broadcast channel (PBCH), channel state information reference signal (CSI-RS), control channel transmission such as physical uplink control channel (PUCCH)/physical downlink control channel (PDCCH), physical data channel such as physical uplink shared channel (PUSCH)/physical downlink shared channel (PDSCH), and uplink sounding reference signal (SRS) transmission, channel sensing should be applied to determine the channel availability before the physical signal is transmitted using the channel.

The radio resource management (RRM) procedures in NR-U are generally similar to those in LAA, because NR-U endeavors to reuse LAA/eLAA/feLAA technologies as much as possible to handle the coexistence between NR-U and other legacy radio access technologies (RATs). RRM measurements and reports may use special configuration procedure with respect the channel sensing and channel availability.

Channel access/selection for LAA is an important aspect for co-existence with other RATs such as Wi-Fi. For example, LAA may use carriers that are congested with Wi-Fi.

Listen-before-talk is designed for unlicensed spectrum co-existence with other RATs. A radio device applies a clear channel assessment check (i.e., channel sensing) before any transmission. The assessment involves energy detection (ED) over a time period compared to a certain energy detection threshold (ED threshold) to determine if a channel is idle. If the transmitter determines the channel is occupied, the transmitter performs a random back-off within a contention window before the next CCA attempt.

To protect the acknowledgement (ACK) transmissions, the transmitter must defer a period after each busy CCA slot prior to resuming back-off. As soon as the transmitter has grasped access to a channel, the transmitter is only allowed to perform transmission up to a maximum time duration (namely, the maximum channel occupancy time (MCOT)). For quality of service (QoS) differentiation, a channel access priority based on the service type is defined. For example, four LBT priority classes are defined for differentiation of channel access priorities between services using different contention window sizes (CWS) and MCOT durations.

As described in 3GPP TR 38.889, the channel access schemes for NR-based access for unlicensed spectrum can be classified into the following categories.

Cat-1: Immediate transmission after a short switching gap. This is used for a transmitter to immediately transmit after a uplink/downlink switching gap inside a COT. The switching gap from reception to transmission is to accommodate the transceiver turnaround time and is no longer than 16 μs.

Cat-2: LBT without random back-off. The duration of time that the channel is sensed to be idle before the transmitting entity transmits is deterministic.

Cat-3: LBT with random back-off with a contention window of fixed size. The transmitting entity draws a random number N within a contention window. The size of the contention window is specified by the minimum and maximum value of N. The size of the contention window is fixed. The random number N is used in the LBT procedure to determine the duration of time that the channel is sensed to be idle before the transmitting entity transmits on the channel.

Cat-4: LBT with random back-off with a contention window of variable size. The transmitting entity draws a random number N within a contention window. The size of contention window is specified by the minimum and maximum value of N. The transmitting entity can vary the size of the contention window when drawing the random number N. The random number N is used in the LBT procedure to determine the duration of time that the channel is sensed to be idle before the transmitting entity transmits on the channel.

For different transmissions in a COT and different channels/signals to be transmitted, different categories of channel access schemes can be used.

The conventional four-step random access (RA) is the current standard for legacy systems such as LTE and NR Release 15. A two-step procedure where the uplink messages (PRACH+Msg3) are sent simultaneously and similarly the two downlink messages (e.g., time advance command in random access response (RAR) and contention resolution information) are sent as a simultaneous response in the downlink.

In the legacy four step RA procedure, one major purpose of the first two messages is to obtain uplink time alignment for the user equipment (UE). In many situations, e.g., in small cells or for stationary UEs, this may not be needed because either a timing advance (TA)=0 is sufficient (small cells) or a stored TA value from the last RA may be used for the current RA (stationary UE). In future radio networks, these situations may be common, both due to dense deployments of small cells and a great number of e.g. stationary IoT devices. A possibility to skip the message exchange in cases where there is no need to obtain the TA value leads to reduced RA latency and is beneficial in several use cases, such as when transmitting infrequent small data packets. On the other hand, the two step RA consumes more resources because it uses contention-based transmission of the data. This means that the resources that are configured for the data transmission may often be unused.

If both the four-step and two-step RA are configured in a cell (and for the UE), the UE may choose its preamble from one specific set if it wants to do a four-step RA, and from another preamble set if the UE wants to do a two-step RA. A preamble partition distinguishes between four-step and two-step RA. Alternatively, the PRACH configurations are different for the two-step and four-step RA procedure, in which case it can be deduced from where the preamble transmission is performed if the UE is doing a two-step or four-step procedure.

The legacy four-step RA has been used in LTE and is also proposed as baseline for NR. An example of the four-step RA procedure is illustrated in FIG. 1.

FIG. 1 is a sequence diagram illustrating an example four-step random access procedure. Step 1 is preamble transmission. The UE randomly selects a RA preamble (PREAMBLE_INDEX) which is then transmitted by the UE. When the eNB detects the preamble, it estimates the timing alignment (TA) the UE should use to obtain uplink synchronization at the eNB.

Step 2 is RA response (RAR). The eNB sends a RA response including the TA, the temporary cell radio network temporary identifier (TC-RNTI) to be used by the UE, a random access preamble identifier that matches the transmitted PREAMBLE_INDEX and a grant for Msg3. The UE expects the RAR, and thus monitors PDCCH addressed to random access RNTI (RA-RNTI) to receive the RAR message from the eNB until the configured RAR window (ra-Response Window) has expired or until the RAR has been successfully received.

According to 38.321, the MAC entity may stop ra-ResponseWindow (and thus monitoring for random access response(s)) after successful reception of a random access response containing random access preamble identifiers that matches the transmitted PREAMBLE_INDEX.

Step 3 is “Msg3” (UE ID or UE-specific C-RNTI). In Msg3 the UE transmits its identifier (UE ID) for initial access or, if the UE is already in RRC_CONNECTED or RRC_INACTIVE mode and needs to e.g. resync, the UE transmits its UE-specific RNTI. If the gNB cannot decode Msg3 at the granted uplink resources, it may send a downlink control information (DCI) addressed to TC-RNTI for retransmission of Msg3. Hybrid automatic repeat request (HARQ) retransmission is requested until the UE restarts the random access procedure from step 1 after reaching the maximum number of HARQ retransmissions or until Msg3 can be successfully received by the gNB.

Step 4 is “Msg4” (contention resolution). In Msg4 the eNB responds by acknowledging the UE ID or C-RNTI. The Msg4 gives contention resolution, i.e. only one UE ID or C-RNTI will be sent even if several UEs have used the same preamble (and the same grant for Msg3 transmission) simultaneously. For Msg4 reception, the UE monitors TC-RNTI (if it transmitted its UE ID in Msg3) or C-RNTI (if it transmitted its C-RNTI in Msg3).

In LTE, the four-step RA cannot be completed in less than 14 ms/TTI/SF.

The two-step RA gives much shorter latency than the ordinary four-step RA. In two-step RA, the preamble and a message corresponding to Msg3 in the four-step RA are transmitted in the same or in two subsequent subframes (msgA). The Msg 3 is sent on a resource dedicated to the specific preamble. This means that both the preamble and the Msg 3 face contention but contention resolution in this case means that either both preamble and Msg 3 are sent without collision or both collide. An example of the two-step RA procedure is illustrated in FIG. 2.

FIG. 2 is a sequence diagram illustrating the two-step random access procedure. Upon successful reception of msgA, the eNB responds with a msgB containing TA (which by assumption should not be needed or just give very minor updates), potentially a contention resolution id, and C-RNTI.

An issue that may occur if the UE TA is not accurate (e.g., using TA=0 in a large cell or using an old TA even though the UE has moved) is that only the preamble can be detected by the eNB. A transmission with an inaccurate TA value may interfere with transmissions from other UEs in the same cell. Additionally, the preamble signal has higher detection probability than the normal data due to its design pattern. In this case the network may reply with an ordinary RAR giving the UE an opportunity to transmit an ordinary Msg3 on a scheduled resource. This is a fallback to four-step RA.

3GPP specifications include a description of the two-step RACH structure. A PUSCH for two-step RACH is defined as the time-frequency resource for payload transmission. One or more PUSCH occasion(s) within a msgA PUSCH configuration period are configured. For separate PUSCH configuration, the msgA PUSCH configuration period may or may not be the same as PRACH configuration period. For PUSCH configuration with relative location, msgA PUSCH configuration period is the PRACH configuration period.

The configuration period refers to the RACH occasions (Ros) in the PRACH time domain that repeat after a certain time (e.g., 10, 20, 40, 80 or 160 ms). This is given in the PRACH configuration table specified in TS 38.211 Tables 6.3.3.2-2, 6.3.3.2-3, 6.3.3.2-4 for FR1 paired spectrum, FR1 unpaired spectrum and FR2 with unpaired spectrum, respectively.

The PUSCH occasion (PO) refers to the PUSCH resource where the msgA PUSCH part is sent. The RO refers to the RACH/PRACH occasions where the preamble is sent. There is a mapping between preamble index and PUSCH resource so that if the UE selects a certain PO, it will need to use a certain (set of) preamble(s). The ROs are specified using a PRACH configuration index which gives the time domain locations. In addition, the frequency domain locations are given by the parameters msg1-FDM and msg1-FrequencyStart. They are defined in 3GPP TS 38.331.

The msg1-FDM parameter is the number of PRACH transmission occasions frequency division multiplexed in one time instance (see TS 38.211, clause 6.3.3.2). The msg1-FrequencyStart parameter is the offset of lowest PRACH transmission occasion in frequency domain with respect to PRB 0. The value is configured so that the corresponding RACH resource is entirely within the bandwidth of the uplink bandwidth part (BWP) (see TS 38.211, clause 6.3.3.2).

The PUSCH resource unit for two-step RACH is defined as the PUSCH occasion and demodulation reference signal (DMRS) port/DMRS sequence used for a msgA payload transmission. The DMRS sequence generation mechanism may follow Release15.

Some implementations support one-to-one and multiple-to-one mapping between preambles in each RACH occasion and associated PUSCH resource unit. A configurable number of preambles (including one or multiple) may be mapped to one PUSCH resource unit.

Some implementations support multiple msgA PUSCH configurations for a UE. Indication of different msgA PUSCH configurations may include, for example, configuration by different RACH occasions, by different preamble groups, or by UCI.

The specifications may include a mapping between PRACH preamble resource and PUSCH resource unit. A PUSCH resource unit (PRU) is the PUSCH occasion and DMRS port/DMRS sequence used for a msgA payload transmission. For mapping between preambles in each RO and associated PUSCH resource unit, the design may consider factors such as resource utilization efficiency and decoding complexity at gNB.

One-to-one and multiple(N)-to-one may be supported. For different RA events and different purposes, the payload size of a msgA may vary in a range from a few bytes to a few hundred bytes. For better spectral efficiency, different mapping rules between preambles in each RO and associated PUSCH resource unit may include one-to-one mapping, many-to-one mapping, and one-to-many mapping.

Multiple msgA PUSCH configurations are possible. Different msgA PUSCH configurations may be of different properties in terms of the configuration periodicity, PUSCH occasion size (i.e., the resource size associated with the PO), number of POs/PRUs within each configuration period, modulation coding scheme (MCS), etc. These properties affect the data transmission performance in terms of QoS indicators such as latency, transmission reliability and transport block (TB) size. The different configurations could enable the UE to select a TB size suitable to the number of bits it needs to transmit or the reliability it needs. For example, a UE that only needs to obtain time alignment may select a smaller PUSCH resource than a UE doing initial access which would require transmission of a radio resource control (RRC) message in msgA. An example configuration of PRACH and PUSCH is illustrated in FIG. 3A.

FIG. 3A is a time/frequency diagram illustrating PRACH and PUSCH configurations. Some implementations may support different configuration periods for PRACH and PUSCH. An example is illustrated in FIG. 3B.

FIG. 3B is a time/frequency diagram illustrating different configuration periods for PRACH and PUSCH. PUSCH configuration 1 has a different periodicity than PUSCH configuration 2 and 3.

There currently exist certain challenges. For example, PUSCH configurations for msgA in a two-step RA procedure are resource consuming in the sense that they occupy many PRBs (compared to PRACH) to accommodate a certain random access load. This means that configurations must be done with care. Further, because different PUSCH configurations may give different performance, there is a risk that most UEs will select the same PUSCH configuration resulting in overloading one PUSCH configuration while other PUSCH configurations are unused.

### SUMMARY

Based on the description above, certain challenges currently exist with two-step random access. Certain aspects of the present disclosure and their embodiments may provide solutions to these or other challenges. For example, particular embodiments categorize random access events with different priority classes (based on one or more criteria described in more detail below) and define a mapping relation between msgA physical uplink shared channel (PUSCH) configurations and random access priority classes. On a high level, different random access events may use a particular set of the msgA PUSCH configurations.

According to some embodiments, a method performed by a wireless device for two-step random access comprises determining a physical uplink shared channel (PUSCH) configuration for transmitting a first message of a two-step random access procedure. The PUSCH configuration is determined based on a characteristic or function of the wireless device. The method further comprises transmitting the first message of the two-step random access procedure to a network node using the determined PUSCH configuration.

In particular embodiments, the characteristic or function of the wireless device comprises one or more of a type of data to be transmitted by the wireless device, a type of data that triggered the two-step random access procedure, a type of event that triggered the two-step random access procedure, a purpose of the two-step random access procedure, a number of previously unsuccessful random access procedures, and a type of data to be transmitted or received. The characteristic or function of the wireless device may comprise one or more of an access class or category of the wireless device, an application identifier of an application supported by the wireless device, a logical channel identifier associated with data to be transmitted or received, a logical channel priority associated with data to be transmitted or received, a radio bearer identifier associated with data to be transmitted or received, and a session identifier associated with data to be transmitted or received. The characteristic or function of the wireless device may comprise a radio resource control (RRC) state of the wireless device.

In particular embodiments, each PUSCH configuration of a plurality of PUSCH configurations is associated with a resource load status. Determining the PUSCH configuration based on the characteristic or function of the wireless device comprises determining a PUSCH configuration with a load status that minimizes a PUSCH network load.

In particular embodiments, each PUSCH configuration of a plurality of PUSCH configurations is associated with a resource load status. Determining the PUSCH configuration based on the characteristic or function of the wireless device comprises determining a PUSCH configuration with a load status that provides a coverage or channel quality above a threshold level.

In particular embodiments, determining the PUSCH configuration further comprises performing a clear channel assessment of two or more PUSCH configurations and selecting a PUSCH configuration of the two or more PUSCH configurations that passes the clear channel assessment.

In particular embodiments, determining the PUSCH configuration further comprises measuring a channel occupancy of two or more PUSCH configurations and selecting a PUSCH configuration of the two or more PUSCH configurations with a lowest channel occupancy.

In particular embodiments, the PUSCH configuration comprises a configuration of one or more of: time/frequency resources of the PUSCH, a PUSCH periodicity, a number of PUSCH occasions (POs) during each PUSCH period, PUSCH resource sizes associated with a PO, modulation and coding scheme associated with a PO, and a number of POs within each configuration period.

In particular embodiments, the method further comprises obtaining a mapping of PUSCH configurations and a priority associated with each PUSCH configuration. Determining the PUSCH configuration based on the characteristic or function of the wireless device comprises determining a priority associated with the characteristic or function of the wireless device and selecting a PUSCH configuration based on the mapping and the determined priority.

In particular embodiments, the characteristic or function of the wireless device comprises a random access triggering event, and the determined priority of a wireless device in an RRC ACTIVE state is a higher priority than a wireless device in an RRC INACTIVE state.

In particular embodiments, the characteristic or function of the wireless device comprises a purpose of the two-step random access procedure, and a purpose comprising handover or beam failure recovery has a higher priority than other purposes.

According to some embodiments, a wireless device is capable of two-step random access. The wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method in a network node for two-step random access comprises receiving a first message of a two-step random access procedure from a wireless device. The first message is received in a PUSCH having a PUSCH configuration determined based on a characteristic or function of the wireless device. The method further comprises performing the two-step random access procedure using the received message.

In particular embodiments, the characteristic or function of the wireless device comprises one or more of a type of data to be transmitted by the wireless device, a type of data that triggered the two-step random access procedure, a type of event that triggered the two-step random access procedure, a purpose of the two-step random access procedure, a number of previously unsuccessful random access procedures, and a type of data to be transmitted or received. The characteristic or function of the wireless device may comprise one or more of an access class or category of the wireless device, an application identifier of an application supported by the wireless device, a logical channel identifier associated with data to be transmitted or received, a logical channel priority associated with data to be transmitted or received, a radio bearer identifier associated with data to be transmitted or received, and a session identifier associated with data to be transmitted or received. The characteristic or function of the wireless device may comprise a RRC state of the wireless device. The characteristic or function of the wireless device may comprise a PUSCH resource load status or a coverage or channel quality.

In particular embodiments, the PUSCH configuration comprises a configuration of one or more of: time/frequency resources of the PUSCH, a PUSCH periodicity, a number of PUSCH occasions (POs) during each PUSCH period, PUSCH resource sizes associated with a PO, modulation and coding scheme associated with a PO, and number of POs within each configuration period.

In particular embodiments, the method further comprises obtaining a mapping of PUSCH configurations to characteristics or functions of the wireless device and transmitting the mapping to the wireless device.

According to some embodiments, a network node is capable of two-step random access. The network node comprises processing circuitry operable to perform any of the network node methods described above.

Another computer program product comprises a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments control the PUSCH load, enhance random access performance, and enhance quality of service (QoS) of associated services.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a sequence diagram illustrating an example four-step random access procedure;

FIG. 2 is a sequence diagram illustrating the two-step random access procedure;

FIG. 3A is a time/frequency diagram illustrating PRACH and PUSCH configurations;

FIG. 3B is a time/frequency diagram illustrating different configuration periods for PRACH and PUSCH;

FIG. 4 is a block diagram illustrating an example wireless network;

FIG. 5 illustrates an example user equipment, according to certain embodiments;

FIG. 6A is flowchart illustrating an example method in a wireless device, according to certain embodiments;

FIG. 6B is flowchart illustrating an example method in a network node, according to certain embodiments;

FIG. 7 illustrates a schematic block diagram of a wireless device and a network node in a wireless network, according to certain embodiments;

FIG. 8 illustrates an example virtualization environment, according to certain embodiments;

FIG. 9 illustrates an example telecommunication network connected via an intermediate network to a host computer, according to certain embodiments;

FIG. 10 illustrates an example host computer communicating via a base station with a user equipment over a partially wireless connection, according to certain embodiments;

FIG. 11 is a flowchart illustrating a method implemented, according to certain embodiments;

FIG. 12 is a flowchart illustrating a method implemented in a communication system, according to certain embodiments;

FIG. 13 is a flowchart illustrating a method implemented in a communication system, according to certain embodiments; and

FIG. 14 is a flowchart illustrating a method implemented in a communication system, according to certain embodiments.

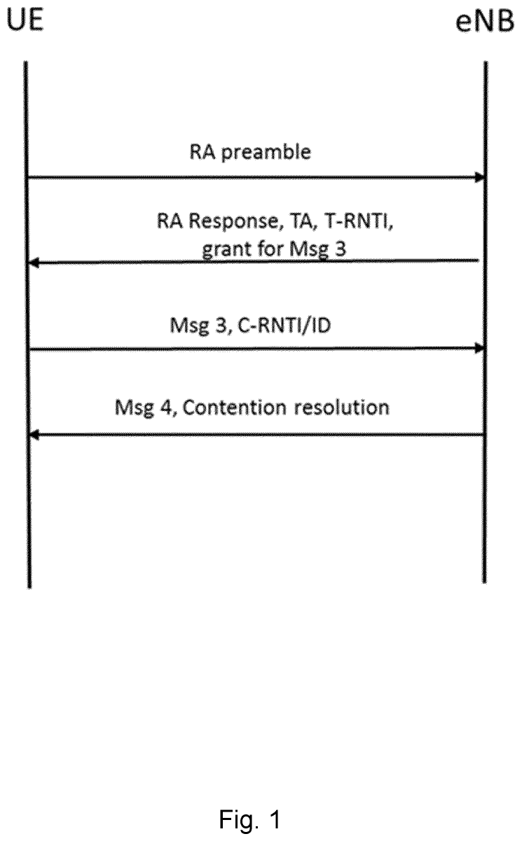

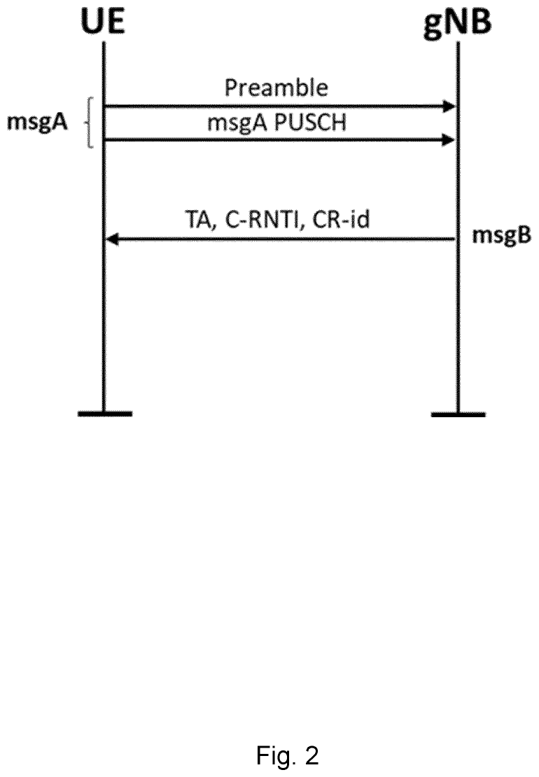

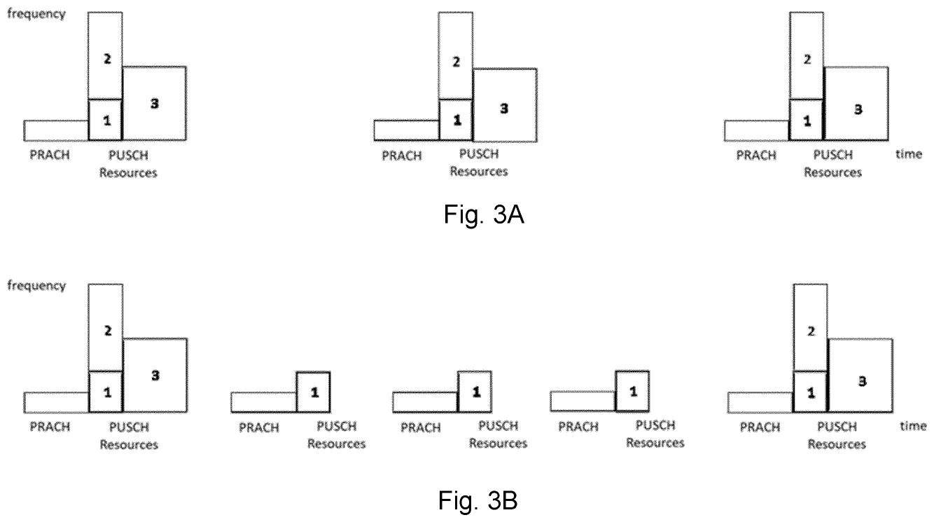

### DETAILED DESCRIPTION

As described above, certain challenges currently exist with two-step random access. For example, physical uplink shared channel (PUSCH) configurations for msgA in a two-step random access procedure are resource consuming because they occupy many more physical resource blocks (PRBs) compared to a physical random access channel (PRACH). Further, because different PUSCH configurations may give different performance, many user equipment (UE) may select the same PUSCH configuration resulting in overloading one PUSCH configuration while other PUSCH configurations are unused.

Certain aspects of the present disclosure and their embodiments may provide solutions to these or other challenges. For example, particular embodiments map msgA PUSCH configurations and random access events. On a high level, different random access events may use a particular set of the msgA PUSCH configurations. An advantage of particular embodiments is that they control the PUSCH load, enhance random access performance, and enhance quality of service (QoS) of associated services.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Particular embodiments are applicable to both unlicensed and licensed spectrum. New radio unlicensed (NR-U) is one example of an unlicensed spectrum scenario. Particular embodiments are also applicable to other unlicensed operation scenarios such as long term evolution (LTE) licenses assisted access (LAA), enhanced LAA, further enhanced LAA, MulteFire, etc.

In some examples, a PUSCH configuration is determined for a wireless device (e.g., UE) for performing a random access procedure. The random access procedure is a two-step random access procedure, and in particular, the PUSCH configuration is for the first message from the UE to the network, also referred to as msgA.

The PUSCH configuration may refer to one or more of the following attributes of the PUSCH: the time/frequency resources of the PUSCH, configuration properties such as configuration periodicity, number of PUSCH occasions (POs) during each configuration period, PUSCH resource sizes and modulation and coding schemes (MCSs) associated with a PO, PO size (i.e., the resource size associated with the PO), number of POs/PRUs within each configuration period, MCS, etc. The properties affect the data transmission performance in terms of QoS indicators such as latency, transmission reliability and transport block (TB) size.

The PUSCH configuration is determined based on a characteristic or function of the wireless device. For example, the characteristic or function of the wireless device may refer to one or more of: a configured parameter or state of the wireless device, the requirements of the wireless device, the type of data to be transmitted, the reason/requirement for the random access, e.g., the type of event triggering the random access, and characteristics of previous attempts at random access. These are explained in further detail below. For example, the PUSCH configuration used for the random access message may be based on a wireless device characteristic or function such as, for example:

1.) A type of data that will be sent by the wireless device. In some examples, this is the type of data that triggered the random access procedure, the type of event that triggered the random access, or the access class or category of the wireless device. The characteristic may be a purpose of the random access, e.g. initial access, requesting system information (SI), obtaining a grant, restoring synchronization, beam failure recovery (BFR), handover, etc. The characteristic or function of the wireless device may relate to the type of data, for example, a priority of data, QoS of data, or other property of the data that will be, or has already been, transmitted or received. The characteristic or function of the wireless device may relate to a characteristic of any layer used by the wireless device for communication with the network, e.g., a characteristic of the radio bearer such as radio bearer ID.

2.) A function of the wireless device may relate to an expected or actual load status of the PUSCH to be used or channel occupancy of the PUSCH resources. The PUSCH configuration may, for example, be determined according to which PUSCH configuration results in a low channel occupancy. The PUSCH configuration for the message may be based on a required coverage or radio quality.

3.) The characteristic or function of the wireless device may relate to previous attempts at random access, for example, a number of failed attempts at random access. The number of failed attempts may be for two-step random access, as one example. The PUSCH configuration for a msgA may be configured to be different than the PUSCH configuration for the msgA previously used.

4.) The characteristic or function of the wireless device may be based on the radio resource control (RRC) state of the wireless device, e.g. RRC Idle, RRC Inactive, RRC Connected state. For example, one or more msgA PUSCH configurations are associated with one or more RRC states. One or more different msgA PUSCH configurations are associated with one or more different RRC states.

The msgA PUSCH configuration is determined based on one or more of the example characteristics or functions of the wireless device. The wireless device comprises processing and radio circuitry to perform random access using the determined PUSCH configuration, in particular, to transmit the msgA in two-step random access using the determined PUSCH configuration.

In some aspects, one or more of the characteristic or function is categorized with a priority level or class. The determination of the msgA PUSCH configuration may be based on the categorized priority level, or directly on the characteristic or function of the wireless device. In some aspects, only some of the PUSCH configurations are used with only some of the example characteristics or functions. Thus, sets of PUSCH configurations are used by different characteristic or function or priority classes.

In some aspects, a network node, e.g. base station or gNB, is configured to carry out random access with a wireless device according to any example. The network node is configured to receive the msgA according to the determined PUSCH configuration. In some examples, the network node is configured to configure a wireless device with one or more configurations, e.g. parameter values or a mapping, which determine a mapping between the characteristic or function of the wireless device and the PUSCH configuration used by the wireless device for two-step random access.

In some embodiments, there is a mapping, or a gNB configures a mapping, relation between msgA PUSCH configuration and a random access (RA) priority class. The configurations that are able to achieve better QoS guarantee (e.g., in terms of latency, transmission reliability, etc.) for a RA procedure are mapped to RA events with higher priority.

For UEs in RRC IDLE, the typical events are initial access or requesting system information (SI). There are a number of ways to determine a priority order for a RA event. One example is to determine the priority order (or priority class) based on the data that triggers the RA. An application ID or some other global indication of application type may be used. Typically, each application running in Android or IOS has an Android application id (=OS specific application ID identifier) assigned by the application developer. Another example is to use the UE's access class or access category, which is typically used for the initial access control, e.g., access barring.

The access class or access category may also apply to UEs in RRC Connected or RRC Inactive, because the term “access category” was introduced in NR Rel-15 for a unified access framework including accesses triggered in RRC IDLE.

For UEs in RRC Connected or RRC Inactive, the typical events are RA to obtain a grant, hand over, regaining of synchronization, beam failure recovery, etc.

In some embodiments, in NR Rel-15 for example, RA events for handover and BFR are prioritized over other RA events. In some embodiments, the priority level of a RA event is determined considering the priority level of data, i.e. the data that triggers the RA for obtaining a grant). For example, the data may include the logical channel (LCH) priority of a LCH containing data. The other QoS identifiers, like the radio bearer ID, logical channel group ID, or session/flow ID (e.g., 5QI, or QFI in NR network, while QCI in LTE network) may be also applied.

For some embodiments, the mapping relation between msgA PUSCH configurations and RA priority classes may be captured in a table. In the table, each configuration (e.g., with a configuration index) may be mapped to a specific type of RA events (e.g., associated with an index indicating RA event type, or LCH priority, or other QoS identifiers, like the radio bearer ID, logical channel group ID, or session/flow ID (e.g., 5QI, or QFI in NR network, while QCI in LTE network). The table may be hard coded in a specification or signaled to UEs via system information, dedicated RRC signaling, media access control (MAC) control element (CE) or downlink control information (DCI). As another alternative, the mapping relation between msgA PUSCH configurations and RA priority classes may be captured as rules in a specification.

In some embodiments, each msgA PUSCH configuration may be associated with a priority level (or priority class). When a RA event is associated with multiple msgA PUSCH configurations, the UE (or network) may select a suitable configuration with highest priority level for transmission of the msgA payload.

In some embodiments, each msgA PUSCH configuration has different configuration properties such as configuration periodicity, number of POs during each configuration period, PUSCH resource sizes and MCSs (Modulation Coding Scheme) associated with POs. The MCS provides the modulation order/type and/or coding scheme used for transmission. The choice of MCS affects the reliability that a transmission is received. In some examples, each configuration may be associated with a different load status (e.g., percentage of PUSCH resources occupied among all configured resources, or channel occupancy measured in the frequency/time region that the configuration belongs to), different requirements for coverage or channel quality to use the resources, etc. If a RA event is associated with multiple msgA PUSCH configurations, the UE (or network) may select a suitable configuration, for example, with either lowest load, or fulfilling the required coverage/radio quality threshold for transmission of the msgA payload.

In one example, each msgA PUSCH configuration is associated with a reference signal receive power (RSRP) threshold (or range of threshold). For example, the UE may measure its downlink RSRP, e.g., via SSB or CSI-RS. The UE then selects a msgA PUSCH configuration whose RSRP threshold is fulfilled by (i.e. is suitable for, based on) the UE's measured downlink RSRP. In another example, when a RA event is triggered in an unlicensed spectrum scenario, the UE may perform parallel listen-before-talk (LBT) operations for multiple msgA PUSCH configurations and choose the msgA PUSCH configuration that has passed LBT operation. In yet another example, when a RA event is triggered in an unlicensed spectrum scenario, the UE may measure channel occupancy of each configuration and select the configuration with lowest channel occupancy for RA. Aspects of the disclosure are applicable to two-step random access for both licensed and unlicensed spectrum.

In some embodiments, after the UE has determined a msgA PUSCH configuration for a triggered RA event, after a configured number of times of RA attempts or a configured time period, if the UE cannot successfully transmit the msgA, the UE is configured to switch to another msgA PUSCH configuration. If the initially determined msgA PUSCH configuration is not successful for a number of times or time period, the msgA PUSCH configuration is changed to a different msgA PUSCH configuration.

In some embodiments, a msgA PUSCH configuration may be determined based on an RRC state. For example, some PUSCH configurations are only used for UEs in RRC connected while others are only used for UEs in RRC Idle or RRC Inactive. The msgA PUSCH configuration is based on the UE's RRC state (e.g., RRC Connected, RRC Idle or RRC Inactive).

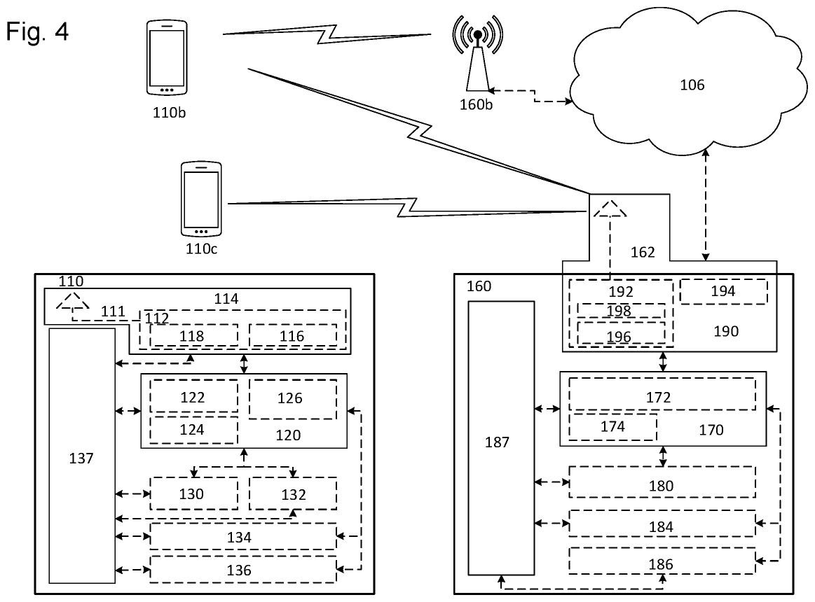

FIG. 4 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 4, network node 160 includes processing circuitry 170, device readable medium 180, interface 190, auxiliary equipment 184, power source 186, power circuitry 187, and antenna 162. Although network node 160 illustrated in the example wireless network of FIG. 4 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 4 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen; if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source; in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

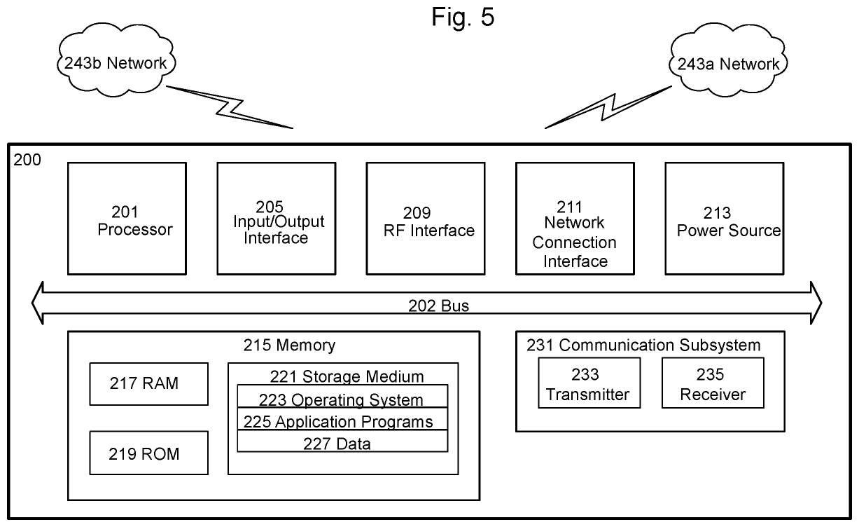

FIG. 5 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 5 is a UE, the components discussed herein are equally applicable to a WD, and vice-versa.

In FIG. 5, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 5, or only a subset of the components. The level of integration between the components may vary from one UE to another UE. Further, certain UEs may contain multiple instances of a component, such as multiple processors, memories, transceivers, transmitters, receivers, etc.

In FIG. 5, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 5, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 5, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

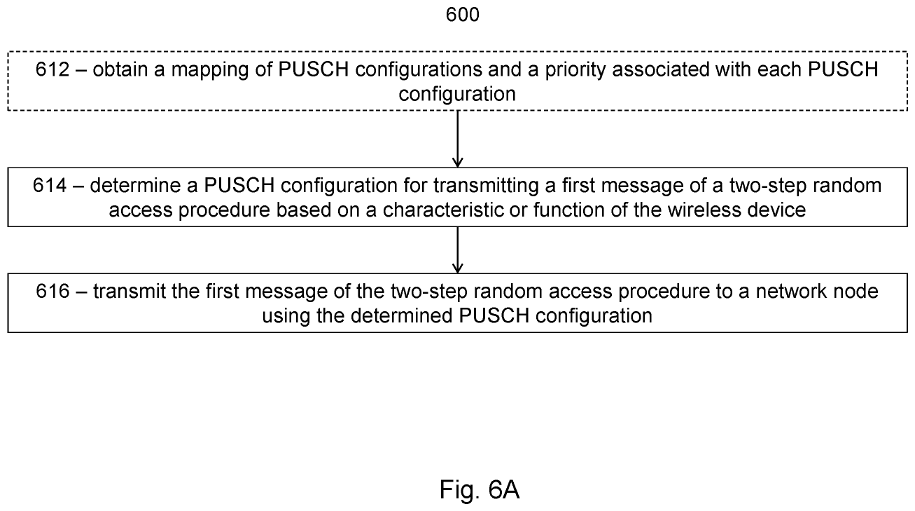

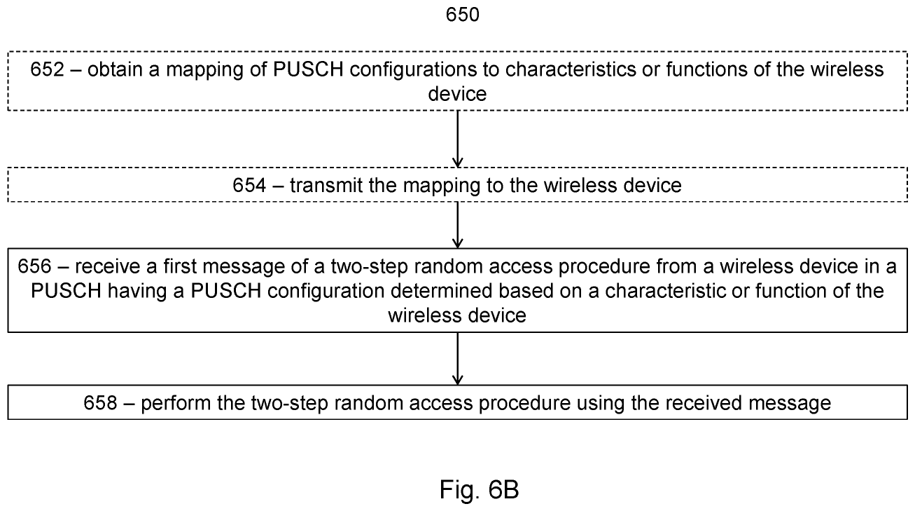

FIG. 6A is a flowchart illustrating an example method in a wireless device, according to certain embodiments. In particular embodiments, one or more steps of FIG. 6A may be performed by wireless device 110 described with respect to FIG. 4.

The method may begin at step 612, where the wireless device (e.g., wireless device 110) obtains a mapping of PUSCH configurations and a priority associated with each PUSCH configuration. For example, wireless device 110 may receive signaling from network node 160 that includes a mapping of PUSCH configurations and a priority associated with teach PUSCH configuration. The wireless device may save the configurations for later use with a two-step random access procedure.

At step 614, the wireless device determines a PUSCH configuration for transmitting a first message of a two-step random access procedure. The PUSCH configuration is determined based on a characteristic or function of the wireless device.

In particular embodiments, the characteristic or function of the wireless device comprises one or more of a type of data to be transmitted by the wireless device, a type of data that triggered the two-step random access procedure, a type of event that triggered the two-step random access procedure, a purpose of the two-step random access procedure, a number of previously unsuccessful random access procedures, and a type of data to be transmitted or received. The characteristic or function of the wireless device may comprise one or more of an access class or category of the wireless device, an application identifier of an application supported by the wireless device, a logical channel identifier associated with data to be transmitted or received, a logical channel priority associated with data to be transmitted or received, a radio bearer identifier associated with data to be transmitted or received, and a session identifier associated with data to be transmitted or received. The characteristic or function of the wireless device may comprise a RRC state of the wireless device.

In particular embodiments, the PUSCH configuration comprises a configuration of one or more of: time/frequency resources of the PUSCH, a PUSCH periodicity, a number of PUSCH occasions (POs) during each PUSCH period, PUSCH resource sizes associated with a PO, modulation and coding scheme associated with a PO, and a number of POs within each configuration period.

Based on the characteristic or function, wireless device 110 can determine which PUSCH configuration to use for two-step random access. For example, some characteristics or functions may be associated with a higher priority than others. The higher priorities may be able to use PUSCH configurations that consume more resources, while lower priorities may be restricted to PUSCH configurations with minimal resources.

In some embodiments, wireless device 110 may directly correlate the characteristic of function with a PUSCH configuration. In other embodiments, wireless device 110 may associate the characteristic or function with a priority level. The PUSCH configurations may also be associated with a priority level. Wireless device 110 may perform a two-step mapping from characteristic of function, to priority level, to associated PUSCH configuration.

In particular embodiments, each PUSCH configuration of a plurality of PUSCH configurations is associated with a resource load status (e.g., percentage of PUSCH resources occupied among all configured resources, or channel occupancy measured in the frequency/time region which the configuration belongs to). Determining the PUSCH configuration based on the characteristic or function of the wireless device comprises determining a PUSCH configuration with a load status that minimizes a PUSCH network load.

In particular embodiments, each PUSCH configuration of a plurality of PUSCH configurations is associated with a resource load status. Determining the PUSCH configuration based on the characteristic or function of the wireless device comprises determining a PUSCH configuration with a load status that provides a coverage or channel quality above a threshold level.

In particular embodiments, determining the PUSCH configuration further comprises performing a clear channel assessment of two or more PUSCH configurations and selecting a PUSCH configuration of the two or more PUSCH configurations that passes the clear channel assessment.

In particular embodiments, determining the PUSCH configuration further comprises measuring a channel occupancy of two or more PUSCH configurations and selecting a PUSCH configuration of the two or more PUSCH configurations with a lowest channel occupancy.

In particular embodiments, the characteristic or function of the wireless device comprises a random access triggering event, and the determined priority of a wireless device in an RRC ACTIVE state is a higher priority than a wireless device in an RRC_INACTIVE state.

In particular embodiments, the characteristic or function of the wireless device comprises a purpose of the two-step random access procedure, and a purpose comprising handover or beam failure recovery has a higher priority than other purposes.

The wireless device may determine the PUSCH configuration according to any of the embodiments and examples described herein.

At step 616, the wireless device transmits the first message of the two-step random access procedure to the network node using the determined PUSCH configuration.

Modifications, additions, or omissions may be made to method 600 of FIG. 6A. Additionally, one or more steps in the method of FIG. 6A may be performed in parallel or in any suitable order.

FIG. 6B is a flowchart illustrating an example method in a network node, according to certain embodiments. In particular embodiments, one or more steps of FIG. 6B may be performed by network node 160 described with respect to FIG. 4.

The method may begin at step 652, where the network node (e.g., network node 160) obtains a mapping of PUSCH configurations to characteristics or functions of the wireless device. For example, network node 160 may receive the mapping from another network node, such as another base station, a core network node, a network management system, etc. Network node 160 may be preconfigured with the mapping and may obtain the mapping from memory or storage.

At step 654, the network node may transmit the mapping to a wireless device. For example, network node 160 may transmit the mapping to wireless device 110. Wireless device 110 may use the mapping to determine a PUSCH configuration for two-step random access.

At step 656, the network node receives a first message of a two-step random access procedure from a wireless device in a PUSCH having a PUSCH configuration determined based on a characteristic or function of the wireless device.

The characteristic or function of the wireless device and PUSCH configuration is described above with respect to step 614 of FIG. 6A.

At step 658, the network performs the two-step random access procedure using the received message.

Modifications, additions, or omissions may be made to method 650 of FIG. 6B. Additionally, one or more steps in the method of FIG. 6B may be performed in parallel or in any suitable order.

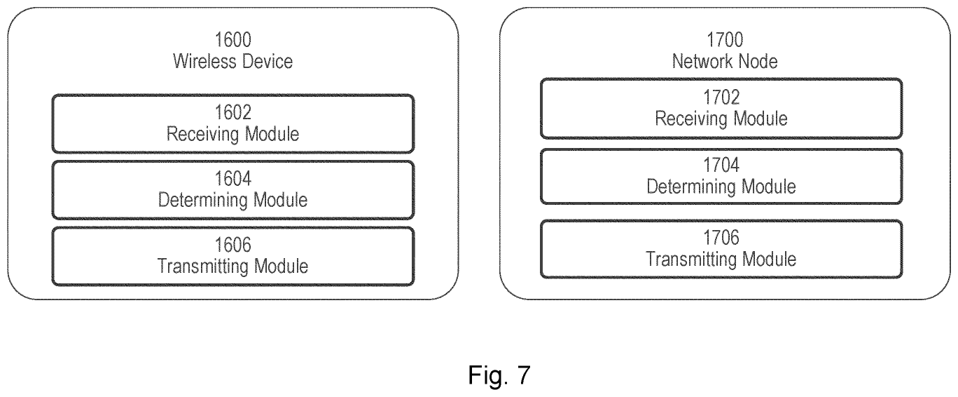

FIG. 7 illustrates a schematic block diagram of two apparatuses in a wireless network (for example, the wireless network illustrated in FIG. 4). The apparatuses include a wireless device and a network node (e.g., wireless device 110 and network node 160 illustrated in FIG. 4). Apparatuses 1600 and 1700 are operable to carry out the example methods described with reference to FIGS. 6A and 6B, respectively, and possibly any other processes or methods disclosed herein. It is also to be understood that the methods of FIGS. 6A and 6B are not necessarily carried out solely by apparatuses 1600 and/or 1700. At least some operations of the methods can be performed by one or more other entities.

Virtual apparatuses 1600 and 1700 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, determining module 1604, transmitting module 1606, and any other suitable units of apparatus 1600 to perform corresponding functions according one or more embodiments of the present disclosure. Similarly, the processing circuitry described above may be used to cause receiving module 1702, determining module 1704, transmitting module 1706, and any other suitable units of apparatus 1700 to perform corresponding functions according one or more embodiments of the present disclosure.

As illustrated in FIG. 7, apparatus 1600 includes receiving module 1602 configured to receive a mapping of PUSCH configurations and a priority associated with each PUSCH configuration, according to any of the embodiments and examples described herein.

Determining module 1604 is configured to determine a PUSCH configuration for transmitting a first message of a two-step random access procedure based on a characteristic or function of the wireless device, according to any of the embodiments and examples described herein. Transmitting module 1606 is configured to transmit a first message of a two-step random access procedure to a network node using the determined PUSCH configuration, according to any of the embodiments and examples described herein.

As illustrated in FIG. 7, apparatus 1700 includes receiving module 1702 configured to receive a first message of a two-step random access procedure from a wireless device in a PUSCH having a PUSCH configuration determined based on a characteristic or function of the wireless device, according to any of the embodiments and examples described herein.

Determining module 1704 is configured to determine a mapping of PUSCH configurations to characteristics or functions of the wireless device, according to any of the embodiments and examples described herein.

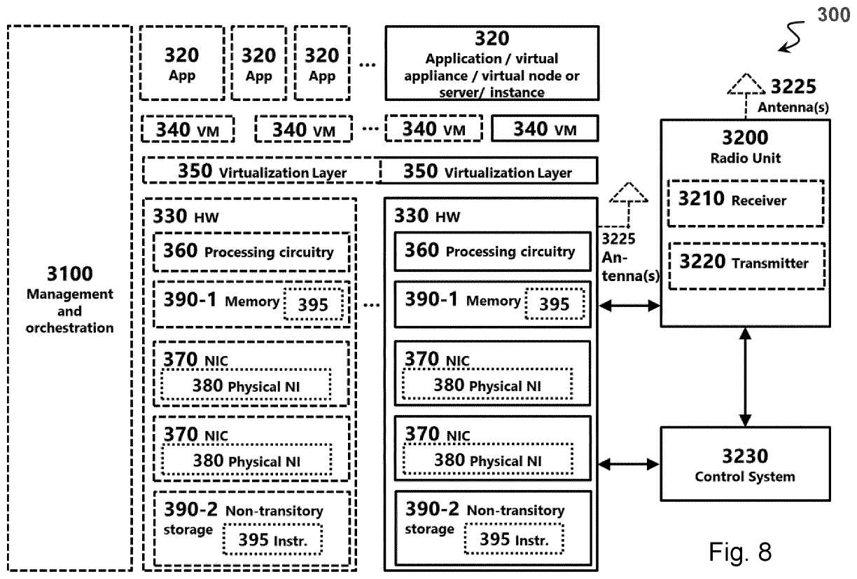

FIG. 8 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 8, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 18.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

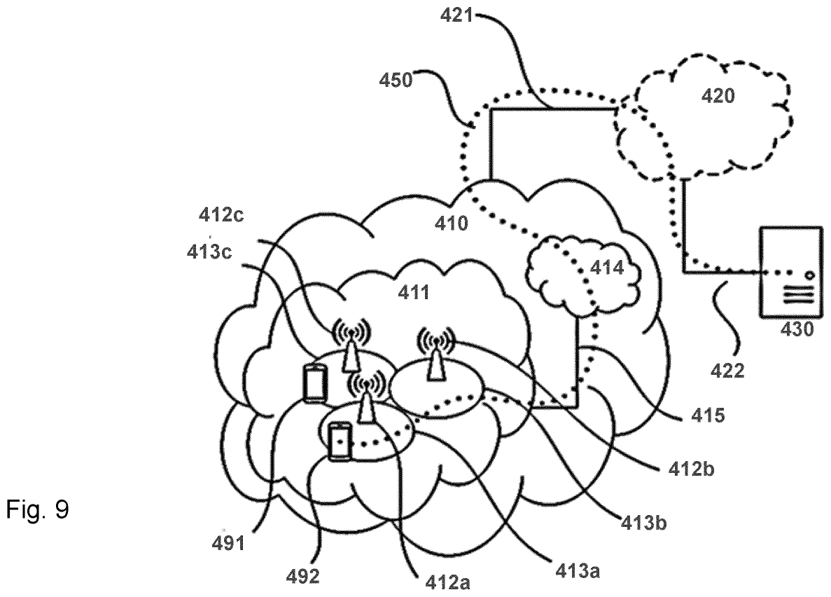

With reference to FIG. 9, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown). The communication system of FIG. 9 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430.

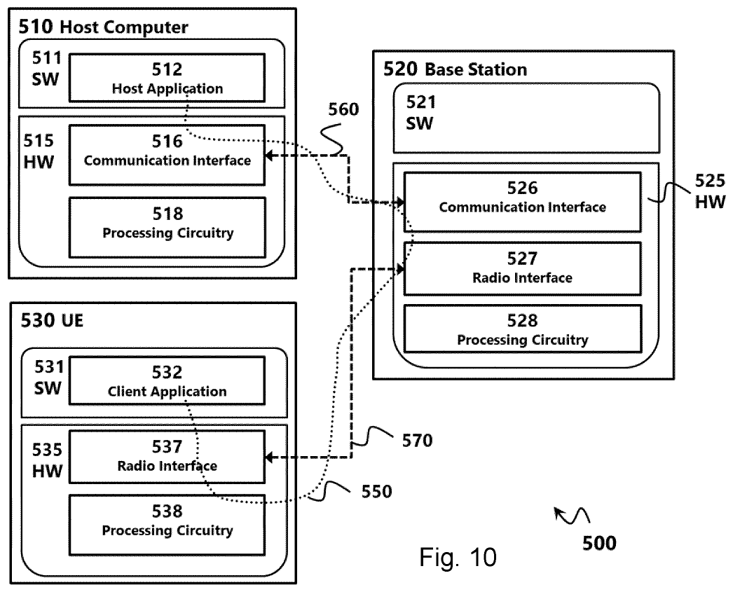

FIG. 10 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 10. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 10) served by base station 520. Communication interface 526 may be configured to facilitate connection 560 to host computer 510. Connection 560 may be direct, or it may pass through a core network (not shown in FIG. 10) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570 with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides. It is noted that host computer 510, base station 520 and UE 530 illustrated in FIG. 10 may be similar or identical to host computer 430, one of base stations 412a, 412b, 412c and one of UEs 491, 492 of FIG. 4, respectively. This is to say, the inner workings of these entities may be as shown in FIG. 10 and independently, the surrounding network topology may be that of FIG. 4.

In FIG. 10, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.; the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

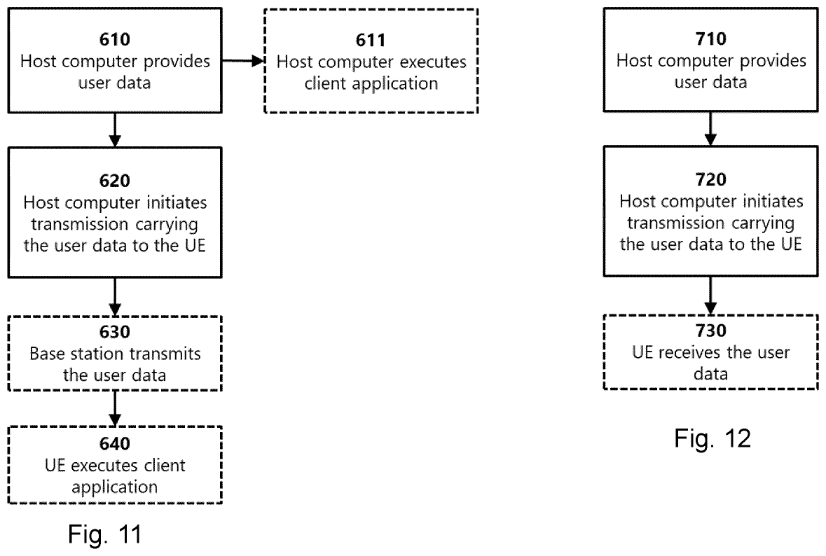

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

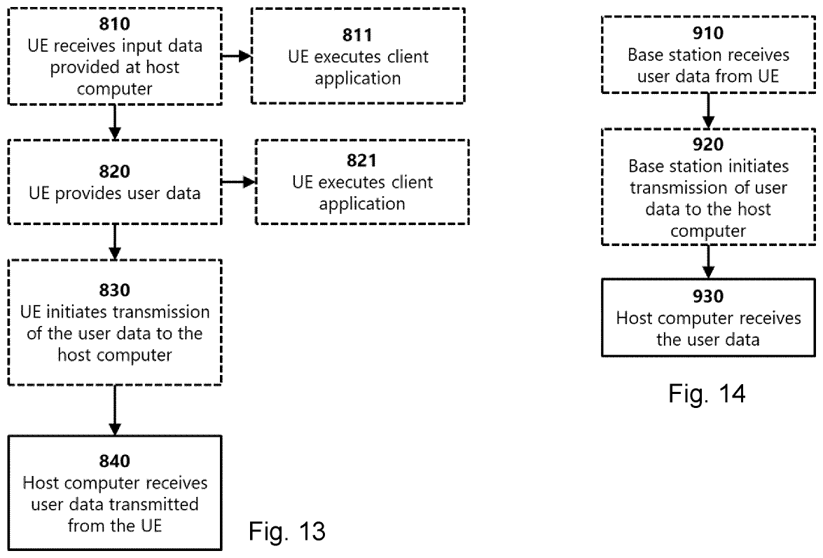

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some example embodiments include the following.

### Group A Embodiments

1A. A method performed by a wireless device for two-step random access, the method comprising:
determining a PUSCH configuration for performing a random access procedure;
wherein the PUSCH configuration is determined based on a characteristic or function of the wireless device; and
performing random access using the determined PUSCH configuration.

2A. The method of embodiment 1A, wherein the characteristic or function of the wireless device comprises one or more of:

a type of data that will be sent by the wireless device, a type of data which triggered the random access procedure, a type of event which triggered the random access, the access class or category of the wireless device, a purpose of the random access, a type of data to be transmitted or received, a characteristic of any layer used by the wireless device for communication with the network.

3A. The method of any one of embodiments 1A-2A, wherein the characteristic or function of the wireless device comprises one or more of:

an expected or actual load status of the PUSCH to be used or channel occupancy of the PUSCH resources, a required coverage or radio quality.

4A. The method of any one of embodiments 1A-3A, wherein the characteristic or function of the wireless device is one or more previous attempts at random access, or, the RRC state of the wireless device.

5A. The method of any one of embodiments 1A-4A, wherein the PUSCH configuration comprises a configuration of one or more of: the time/frequency resources of the PUSCH, a configuration property such as configuration periodicity, number of PUSCH occasions (POs) during each configuration period, PUSCH resource sizes and MCS (Modulation Coding Scheme) associated with a PO, PUSCH occasion (PO) size, number of POs/PRUs within each configuration period, MCS.

6A. The method of any one of embodiments 1A-5A wherein the performing random access using the determined PUSCH configuration comprises transmitting MsgA of the two-step random access using the determined PUSCH configuration.
1. A method performed by a wireless device for two-step random access, the method comprising:
   obtaining a mapping of physical uplink shared channel (PUSCH) random access time/frequency resource configurations and a priority associated with each configuration;
   receiving a random access triggering event;
   determining a priority associated with the random access triggering event;
   selecting a PUSCH random access time/frequency resource configuration using the determined priority and the obtained mapping; and
   performing a random access procedure using the selected PUSCH random access time/frequency resource configuration.
2. The method of embodiment 1, wherein the mapping maps PUSCH random access time/frequency resource configurations that provide higher quality of service (QoS) to higher priorities.
3. The method of any one of embodiments 1-2, wherein determining the priority associated with the random access triggering event is based on data within the triggering event.
4. The method of embodiment 3, wherein the data within the triggering event comprises an application identifier.
5. The method of embodiment 3, wherein the data within the triggering event comprises an access class or category.
6. The method of embodiment 3, wherein the data within the triggering event comprises data associated with a logical channel (LCH) priority.
7. The method of embodiment 3, wherein the data within the triggering event comprises data associated with a radio bearer ID, a logical channel group ID, or a session/flow ID.
8. The method of any one of embodiments 1-2, wherein determining the priority associated with the random access triggering event is based on a type of triggering event.
9. The method of embodiment 8, wherein a handover triggering event and a beam failure recovery (BFR) triggering event are prioritized over other types of triggering events.
10. The method of any one of embodiments 1-9, wherein selecting the configuration is based on a radio resource configuration (RRC) state of the wireless device.
11. The method of any one of embodiments 1-10, wherein selecting the configuration comprises performing listen-before-talk (LBT) operation for one or more PUSCH random access time/frequency resource configurations and selecting a configuration that passes the LBT operation.
12. The method of any one of embodiments 1-10, wherein selecting the configuration comprises performing listen-before-talk (LBT) operation for one or more PUSCH random access time/frequency resource configurations and selecting a configuration based on channel occupancy (CO).
13. The method of any one of embodiments 1-12, wherein each configuration is associated with a load status and selecting the configuration is based on the load status.
14. The method of any one of embodiments 1-12, wherein each configuration is associated with a RSRP threshold and selecting the configuration is based on the RSRP threshold.
15. The method of any one of embodiments 1-14, further comprising:
   determining the random access procedure failed;
   selecting a second configuration; and
   performing a random access procedure using the second configuration.
16. The method of any one of embodiments 1-15, wherein obtaining the mapping comprises receiving the mapping table via RRC, DCI, or MAC CE, or obtaining a preconfigured mapping, wherein the preconfigured mapping is based on a specification or a network operator configuration.
17. The method of any of the previous embodiments, further comprising:
   providing user data; and
   forwarding the user data to a host computer via the transmission to the base station.

### Group B Embodiments

1B. A method performed by a network node for two-step random access, the method comprising:

receiving a message from a wireless device in the two-step random access,

wherein the message has a PUSCH configuration determined based on a characteristic or function of the wireless device; and

performing random access using the determined PUSCH configuration.

2B. The method of embodiment 1B, comprising:
determining a configuration of the wireless device which determines the PUSCH configuration used for the characteristic or function of the wireless device;
transmitting the configuration to the wireless device.

3B. The method of embodiment 1B or 2B, wherein the characteristic or function of the wireless device comprises one or more of:

a type of data that will be sent by the wireless device, a type of data which triggered the random access procedure, a type of event which triggered the random access, the access class or category of the wireless device, a purpose of the random access, a type of data to be transmitted or received, a characteristic of any layer used by the wireless device for communication with the network.

4B. The method of any one of embodiments 1B-3B, wherein the characteristic or function of the wireless device comprises one or more of:

an expected or actual load status of the PUSCH to be used or channel occupancy of the PUSCH resources, a required coverage or radio quality.

5B. The method of any one of embodiments 1B-4B, wherein the characteristic or function of the wireless device is one or more previous attempts at random access, or, the RRC state of the wireless device.

6B. The method of any one of embodiments 1B-5B, wherein the PUSCH configuration comprises a configuration of one or more of: the time/frequency resources of the PUSCH, a configuration property such as configuration periodicity, number of PUSCH occasions (POs) during each configuration period, PUSCH resource sizes and MCS (Modulation Coding Scheme) associated with a PO, PUSCH occasion (PO) size, number of POs/PRUs within each configuration period, MCS.

7. The method of any one of embodiments 1-6 wherein the performing random access using the determined PUSCH configuration comprises receiving MsgA of the two-step random access using the determined PUSCH configuration.
18. A method performed by a base station for two-step random access, the method comprising:
   obtaining a mapping of physical uplink shared channel (PUSCH) random access time/frequency resource configurations and a priority associated with each configuration; and
   transmitting the mapping to a wireless device.
19. The method of embodiment 18, wherein the mapping maps PUSCH random access time/frequency resource configurations that provide higher quality of service (QoS) to higher priorities.
20. The method of any one of embodiments 18-19, wherein transmitting the mapping comprises transmitting via RRC, DCI, or MAC CE.
21. The method of any of the previous embodiments, further comprising:
   obtaining user data; and
   forwarding the user data to a host computer or a wireless device.

### Group C Embodiments

22. A wireless device for two-step random access, the wireless device comprising:
   processing circuitry configured to perform any of the steps of any of the Group A embodiments; and
   power supply circuitry configured to supply power to the wireless device.
23. A base station/network node for two-step random access, the base station/network node comprising:
   processing circuitry configured to perform any of the steps of any of the Group B embodiments;
   power supply circuitry configured to supply power to the wireless device.
24. A user equipment (UE) for two-step random access, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
25. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
26. The communication system of the pervious embodiment further including the base station.
27. The communication system of the previous 2 embodiments, further including the UE, wherein the UE is configured to communicate with the base station.
28. The communication system of the previous 3 embodiments, wherein:
   the processing circuitry of the host computer is configured to execute a host application, thereby providing the user data; and
   the UE comprises processing circuitry configured to execute a client application associated with the host application.
29. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
30. The method of the previous embodiment, further comprising, at the base station, transmitting the user data.
31. The method of the previous 2 embodiments, wherein the user data is provided at the host computer by executing a host application, the method further comprising, at the UE, executing a client application associated with the host application.
32. A user equipment (UE) configured to communicate with a base station, the UE comprising a radio interface and processing circuitry configured to performs any of the previous 3 embodiments.
33. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
34. The communication system of the previous embodiment, wherein the cellular network further includes a base station configured to communicate with the UE.
35. The communication system of the previous 2 embodiments, wherein:
   the processing circuitry of the host computer is configured to execute a host application, thereby providing the user data; and
   the UE's processing circuitry is configured to execute a client application associated with the host application.
36. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
37. The method of the previous embodiment, further comprising at the UE, receiving the user data from the base station.
38. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
39. The communication system of the previous embodiment, further including the UE.
40. The communication system of the previous 2 embodiments, further including the base station, wherein the base station comprises a radio interface configured to communicate with the UE and a communication interface configured to forward to the host computer the user data carried by a transmission from the UE to the base station.
41. The communication system of the previous 3 embodiments, wherein:
   the processing circuitry of the host computer is configured to execute a host application; and
   the UE's processing circuitry is configured to execute a client application associated with the host application, thereby providing the user data.
42. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
43. A method implemented in a communication system including a host computer, a base station and a user equipment (UE), the method comprising:
   at the host computer, receiving user data transmitted to the base station from the UE, wherein the UE performs any of the steps of any of the Group A embodiments.
44. The method of the previous embodiment, further comprising, at the UE, providing the user data to the base station.
45. The method of the previous 2 embodiments, further comprising:
   at the UE, executing a client application, thereby providing the user data to be transmitted; and
   at the host computer, executing a host application associated with the client application.
46. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
47. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
48. The communication system of the previous embodiment further including the base station.
49. The communication system of the previous 2 embodiments, further including the UE, wherein the UE is configured to communicate with the base station.
50. The communication system of the previous 3 embodiments, wherein:
   the processing circuitry of the host computer is configured to execute a host application;
   the UE is configured to execute a client application associated with the host application, thereby providing the user data to be received by the host computer.
51. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
52. The method of the previous embodiment, further comprising at the base station, receiving the user data from the UE.
53. The method of the previous 2 embodiments, further comprising at the base station, initiating a transmission of the received user data to the host computer.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

At least some of the following abbreviations may be used in this disclosure. If there is an inconsistency between abbreviations, preference should be given to how it is used above. If listed multiple times below, the first listing should be preferred over any subsequent listing(s).
1×RTT CDMA2000 1×Radio Transmission Technology
3GPP 3rd Generation Partnership Project
5G 5th Generation
ABS Almost Blank Subframe
ARQ Automatic Repeat Request
AWGN Additive White Gaussian Noise
BCCH Broadcast Control Channel
BCH Broadcast Channel
CA Carrier Aggregation
CC Carrier Component
CCCH SDU Common Control Channel SDU
CDMA Code Division Multiplexing Access
CGI Cell Global Identifier
CIR Channel Impulse Response
CP Cyclic Prefix
CPICH Common Pilot Channel
CPICH Ec/No CPICH Received energy per chip divided by the power density in the band
CQI Channel Quality information
C-RNTI Cell RNTI
CSI Channel State Information
DCCH Dedicated Control Channel
DL Downlink
DM Demodulation
DMRS Demodulation Reference Signal
DRX Discontinuous Reception
DTX Discontinuous Transmission
DTCH Dedicated Traffic Channel
DUT Device Under Test
E-CID Enhanced Cell-ID (positioning method)
E-SMLC Evolved-Serving Mobile Location Centre
ECGI Evolved CGI
eNB E-UTRAN NodeB
ePDCCH enhanced Physical Downlink Control Channel
E-SMLC evolved Serving Mobile Location Center
E-UTRA Evolved UTRA
E-UTRAN Evolved UTRAN
FDD Frequency Division Duplex
GEO Geostationary Orbit
GERAN GSM EDGE Radio Access Network
gNB Base station in NR
GNSS Global Navigation Satellite System
GPS Global Positioning System
GSM Global System for Mobile communication
HARQ Hybrid Automatic Repeat Request
HO Handover
HSPA High Speed Packet Access
HRPD High Rate Packet Data
LEO Low Earth Orbit
LOS Line of Sight
LPP LTE Positioning Protocol
LTE Long-Term Evolution
MAC Medium Access Control
MBMS Multimedia Broadcast Multicast Services
MBSFN Multimedia Broadcast multicast service Single Frequency Network
MBSFN ABS MBSFN Almost Blank Subframe
MDT Minimization of Drive Tests
MEO Medium Earth Orbit
MIB Master Information Block
MIMO Multiple-Input Multiple-Output
MME Mobility Management Entity
MSC Mobile Switching Center
NGSO Non-Geostationary Orbit
NPDCCH Narrowband Physical Downlink Control Channel
NR New Radio
NTN Non-Terrestrial Networks
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
O&M Operation and Maintenance
PA Power Amplifier
PBCH Physical Broadcast Channel
P-CCPCH Primary Common Control Physical Channel
PCell Primary Cell
PCFICH Physical Control Format Indicator Channel
PDCCH Physical Downlink Control Channel
PDP Profile Delay Profile
PDSCH Physical Downlink Shared Channel
PGW Packet Gateway
PHICH Physical Hybrid-ARQ Indicator Channel
PLMN Public Land Mobile Network
PMI Precoder Matrix Indicator
PRACH Physical Random Access Channel
PRS Positioning Reference Signal
PSS Primary Synchronization Signal
PUCCH Physical Uplink Control Channel
PUSCH Physical Uplink Shared Channel
RA Random Access
RACH Random Access Channel
QAM Quadrature Amplitude Modulation
RAN Radio Access Network
RAT Radio Access Technology
RLM Radio Link Management
RNC Radio Network Controller
RNTI Radio Network Temporary Identifier
RRC Radio Resource Control
RRM Radio Resource Management
RS Reference Signal
RSCP Received Signal Code Power
RSRP Reference Symbol Received Power OR Reference Signal Received Power
RSRQ Reference Signal Received Quality OR Reference Symbol Received Quality
RSSI Received Signal Strength Indicator
RSTD Reference Signal Time Difference
SCH Synchronization Channel
SCell Secondary Cell
SDU Service Data Unit
SFN System Frame Number
SGW Serving Gateway
SI System Information
SIB System Information Block
SNR Signal to Noise Ratio
SON Self Optimized Network
SRI SRS resource indicator
SRS Sounding Reference Signal
SS Synchronization Signal
SSS Secondary Synchronization Signal
TDD Time Division Duplex
TDOA Time Difference of Arrival
TFRE Time Frequency Resource Element
TOA Time of Arrival
TPC Transmit Power Control
TPMI Transmit Precoder Matrix Indicator
TRI Transmission Rank Indicator
TRP Transmit Reception Point
TSS Tertiary Synchronization Signal
TTI Transmission Time Interval
UE User Equipment
UL Uplink
UMTS Universal Mobile Telecommunication System
USIM Universal Subscriber Identity Module
UTDOA Uplink Time Difference of Arrival
UTRA Universal Terrestrial Radio Access
UTRAN Universal Terrestrial Radio Access Network
WCDMA Wide CDMA
WLAN Wide Local Area Network

1. A method performed by a wireless device for two-step random access, the method comprising:
determining a physical uplink shared channel (PUSCH) configuration for transmitting a first message of a two-step random access procedure, wherein the PUSCH configuration is determined based on a characteristic or function of the wireless device; and
transmitting the first message of the two-step random access procedure to a network node using the determined PUSCH configuration.

2. The method of claim 1, wherein the characteristic or function of the wireless device comprises one or more of a type of data to be transmitted by the wireless device, a type of data that triggered the two-step random access procedure, a type of event that triggered the two-step random access procedure, a purpose of the two-step random access procedure, a number of previously unsuccessful random access procedures, and a type of data to be transmitted or received.

3. The method of claim 1, wherein the characteristic or function of the wireless device comprises one or more of an access class or category of the wireless device, an application identifier of an application supported by the wireless device, a logical channel identifier associated with data to be transmitted or received, a logical channel priority associated with data to be transmitted or received, a radio bearer identifier associated with data to be transmitted or received, and a session identifier associated with data to be transmitted or received.

4. (canceled)

5. The method of claim 1, wherein each PUSCH configuration of a plurality of PUSCH configurations is associated with a resource load status, and wherein determining the PUSCH configuration based on the characteristic or function of the wireless device comprises determining a PUSCH configuration with a load status that minimizes a PUSCH network load.

6. The method of claim 1, wherein each PUSCH configuration of a plurality of PUSCH configurations is associated with a resource load status, and wherein determining the PUSCH configuration based on the characteristic or function of the wireless device comprises determining a PUSCH configuration with a load status that provides a coverage or channel quality above a threshold level.

7. The method of claim 1, wherein determining the PUSCH configuration further comprises performing a clear channel assessment of two or more PUSCH configurations and selecting a PUSCH configuration of the two or more PUSCH configurations that passes the clear channel assessment.

8.-9. (canceled)

10. The method of claim 1, further comprising obtaining a mapping of PUSCH configurations and a priority associated with each PUSCH configuration; and
wherein determining the PUSCH configuration based on the characteristic or function of the wireless device comprises determining a priority associated with the characteristic or function of the wireless device and selecting a PUSCH configuration based on the mapping and the determined priority.

11.-12. (canceled)

13. A wireless device capable of performing two-step random access, the wireless device comprising processing circuitry operable to:
determine a physical uplink shared channel (PUSCH) configuration for transmitting a first message of a two-step random access procedure, wherein the PUSCH configuration is determined based on a characteristic or function of the wireless device; and
transmit the first message of the two-step random access procedure to a network node using the determined PUSCH configuration.

14. The wireless device of claim 13, wherein the characteristic or function of the wireless device comprises one or more of a type of data to be transmitted by the wireless device, a type of data that triggered the two-step random access procedure, a type of event that triggered the two-step random access procedure, a purpose of the two-step random access procedure, a number of previously unsuccessful random access procedures, and a type of data to be transmitted or received.

15. The wireless device of claim 13, wherein the characteristic or function of the wireless device comprises one or more of an access class or category of the wireless device, an application identifier of an application supported by the wireless device, a logical channel identifier associated with data to be transmitted or received, a logical channel priority associated with data to be transmitted or received, a radio bearer identifier associated with data to be transmitted or received, and a session identifier associated with data to be transmitted or received.

16. (canceled)

17. The wireless device of claim 13, wherein each PUSCH configuration of a plurality of PUSCH configurations is associated with a resource load status, and wherein the processing circuitry is operable to determine the PUSCH configuration based on the characteristic or function of the wireless device by determining a PUSCH configuration with a load status that minimizes a PUSCH network load.

18. The wireless device of claim 13, wherein each PUSCH configuration of a plurality of PUSCH configurations is associated with a resource load status, and wherein the processing circuitry is operable to determine the PUSCH configuration based on the characteristic or function of the wireless device by determining a PUSCH configuration with a load status that provides a coverage or channel quality above a threshold level.

19.-21. (canceled)

22. The wireless device of claim 13, the processing circuitry further operable to obtain a mapping of PUSCH configurations and a priority associated with each PUSCH configuration; and
wherein the processing circuitry is operable to determine the PUSCH configuration based on the characteristic or function of the wireless device by determining a priority associated with the characteristic or function of the wireless device and selecting a PUSCH configuration based on the mapping and the determined priority.

23.-24. (canceled)

25. A method performed by a network node for two-step random access, the method comprising:
receiving a first message of a two-step random access procedure from a wireless device, wherein the first message is received in a physical uplink shared channel (PUSCH) having a PUSCH configuration determined based on a characteristic or function of the wireless device; and
performing the two-step random access procedure using the received message.

26. The method of claim 25, wherein the characteristic or function of the wireless device comprises one or more of a type of data to be transmitted by the wireless device, a type of data that triggered the two-step random access procedure, a type of event that triggered the two-step random access procedure, a purpose of the two-step random access procedure, a number of previously unsuccessful random access procedures, and a type of data to be transmitted or received.

27. The method of claim 25, wherein the characteristic or function of the wireless device comprises one or more of an access class or category of the wireless device, an application identifier of an application supported by the wireless device, a logical channel identifier associated with data to be transmitted or received, a logical channel priority associated with data to be transmitted or received, a radio bearer identifier associated with data to be transmitted or received, and a session identifier associated with data to be transmitted or received.

28. (canceled)

29. The method of claim 25, wherein the characteristic or function of the wireless device comprises a PUSCH resource load status.

30.-31. (canceled)

32. The method of claim 25, further comprising obtaining a mapping of PUSCH configurations to characteristics or functions of the wireless device; and
transmitting the mapping to the wireless device.

33. A network node capable of performing two-step random access, the network node comprising processing circuitry operable to:
receive a first message of a two-step random access procedure from a wireless device, wherein the first message is received in a physical uplink shared channel (PUSCH) having a PUSCH configuration determined based on a characteristic or function of the wireless device; and
perform the two-step random access procedure using the received message.

34. The network node of claim 33, wherein the characteristic or function of the wireless device comprises one or more of a type of data to be transmitted by the wireless device, a type of data that triggered the two-step random access procedure, a type of event that triggered the two-step random access procedure, a purpose of the two-step random access procedure, a number of previously unsuccessful random access procedures, and a type of data to be transmitted or received.

35. The network node of claim 33, wherein the characteristic or function of the wireless device comprises one or more of an access class or category of the wireless device, an application identifier of an application supported by the wireless device, a logical channel identifier associated with data to be transmitted or received, a logical channel priority associated with data to be transmitted or received, a radio bearer identifier associated with data to be transmitted or received, and a session identifier associated with data to be transmitted or received.

36.-38. (canceled)

39. The network node of claim 33, wherein the PUSCH configuration comprises a configuration of one or more of: time/frequency resources of the PUSCH, a PUSCH periodicity, a number of PUSCH occasions (POs) during each PUSCH period, PUSCH resource sizes associated with a PO, modulation and coding scheme associated with a PO, and number of POs within each configuration period.

40. (canceled)
